(19) United States
(12) Patent Application Publication
(10) Pub. No.: US 2010/0021056 A1
(43) Pub. Date: Jan. 28, 2010

(54) SKIN COLOR MODEL GENERATION DEVICE AND METHOD, AND SKIN COLOR DETECTION DEVICE AND METHOD

(75) Inventor: Tao CHEN, Kanagawa-ken (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/509,661

(22) Filed: Jul. 27, 2009

(30) Foreign Application Priority Data
Jul. 28, 2008 (JP) 193151/2008
Jul. 28, 2008 (JP) 193152/2008

(51) Int. Cl. G06K 9/00

(52) U.S. Cl. 382/165

(57) ABSTRACT

A skin color model generation device includes a sample acquiring unit for acquiring a skin color sample region from an image of interest; a feature extracting unit for extracting a plurality of features from the skin color sample region; and a model generating unit for statistically generating, based on the features, a skin color model used to determine whether or not each pixel of the image of interest has a skin color.

### BACKGROUND OF THE INVENTION

1. Field of the Invention

The present invention relates to a skin color model generation device and method for generating a skin color model used to detect a skin color region from an image, a skin color detection device and method for detecting a skin color region from an image, and computer-readable recording media containing programs for causing a computer to carry out the skin color model generation method and the skin color detection method.

2. Description of the Related Art

It is important for an image containing a person that the skin color of the person is appropriately reproduced. Therefore, it is considered that the operator manually specifies a skin color region contained in the image and applies appropriate image processing to the specified skin color region. In order to reduce the burden on the operator, various techniques for automatically detecting the skin color region contained in the image have been proposed.

For example, a technique proposed in Japanese Unexamined Patent Publication No. 2006-313468 (patent document 1) includes: converting the color space of the image into the TSL color space, which facilitates generation of a model defining the skin color; converting a number of sample images, which are used to generate a skin color distribution model, into the TSL color space; generating the skin color distribution model using the converted images; and detecting the skin color using the distribution model. Another technique proposed in Japanese Unexamined Patent Publication No. 2004-246424 (patent document 2) includes: collecting sample data of the skin color from a number of sample images; applying the HSV conversion to the collected skin color image data and collecting (H, S) data of the skin color; approximating a histogram of the collected (H, S) data with a Gaussian mixture model; acquiring parameters of the Gaussian mixture model; calculating for each pixel of an image of interest, from which the skin color is to be detected, a value representing likelihood of the pixel having the skin color (hereinafter “skin color likelihood value”) by using the parameters of the Gaussian mixture model; and determining whether or not each pixel has the skin color by comparing the calculated skin color likelihood value with a threshold value. Further, Japanese Unexamined Patent Publication No. 2007-257087 (patent document 3) has proposed a technique for applying the technique disclosed in the patent document 2 to a moving image.

The techniques disclosed in the patent documents 1-3 use a wide variety of sample images to generate a versatile skin color model for detecting the skin color. However, since images of interest from which the skin color is to be detected contain various persons and the images have been taken under different lighting conditions, the skin colors contained in the sample images used to generate the skin color model and the skin colors contained in the images of interest do not necessarily match. It is therefore highly likely that the skin color model generated according to any of the techniques disclosed in patent documents 1-3 falsely recognizes the skin color, and may fail to accurately detect the skin color region from the images of interest.

### SUMMARY OF THE INVENTION

In view of the above-described circumstances, the present invention is directed to generating a skin color model which allows accurate detection of a skin color region from an image of interest.

The present invention is further directed to accurately detecting a skin color region from an image of interest.

An aspect of the skin color model generation device according to the invention includes: sample acquiring means for acquiring a skin color sample region from an image of interest; feature extracting means for extracting a plurality of features from the skin color sample region; and model generating means for statistically generating, based on the features, a skin color model used to determine whether or not each pixel of the image of interest has a skin color.

In the skin color model generation device according to the invention, the model generating means may generate the skin color model by approximating statistic distributions of the features with a Gaussian mixture model, and applying an EM algorithm using the Gaussian mixture model.

The skin color model generation device according to the invention may further include face detecting means for detecting a face region from the image of interest, wherein the sample acquiring means may acquire, as the skin color sample region, a region of a predetermined range contained in the face region detected by the face detecting means.

In the skin color model generation device according to the invention skin, if more than one face regions are detected from the image of interest, the model generating means may generate the skin color model for each face region.

An aspect of the skin color model generation method according to the invention includes: acquiring a skin color sample region from an image of interest; extracting a plurality of features from the skin color sample region; and statistically generating, based on the features, a skin color model used to determine whether or not each pixel of the image of interest has a skin color.

The skin color model generation method according to the invention may be provided in the form of a computer-readable recording medium containing a program for causing a computer to carry out the method.

According to the skin color model generation device and method of the invention, a skin color sample region is acquired from an image of interest, and a plurality of features are extracted from the skin color sample region. Then, based on the features, a skin color model used to determine whether or not each pixel of the image of interest has a skin color is statistically generated. The thus generated skin color model is suitable for the skin color contained in the image of interest, and use of the generated skin color model allows accurate detection of the skin color region from the image of interest.

Further, automatic acquisition of the skin color sample region, from which the features used to generate the skin color model are extracted, can be achieved by detecting a face region from the image of interest, and acquiring, as the skin color sample region, a region of a predetermined range contained in the detected face region.

If more than one face regions are detected from the image of interest, the skin color model may be generated for each face region, i.e., for each person contained in the image of interest, thereby allowing accurate detection of the skin color regions for all the persons contained in the image of interest.

The skin color detection device according to the invention includes: skin color model generating means for generating, for each person contained in an image of interest, a skin color model used to determine whether or not each pixel of the image of interest has a skin color; and detecting means for detecting a skin color region comprising pixels having the skin color from the image of interest with referencing the skin color model.

In the skin color detection device according to the invention, if more than one skin color models are generated, the detecting means may detect the skin color region for each skin color model.

In the skin color detection device according to the invention, the skin color model generating means may include sample acquiring means for acquiring a skin color sample region from the image of interest; feature extracting means for extracting a plurality of features from the skin color sample region; and model generating means for statistically generating the skin color model based on the features.

In this case, the model generating means may generate the skin color model by approximating statistic distributions of the features with a Gaussian mixture model, and applying an EM algorithm using the Gaussian mixture model. Further, in this case, the skin color detection device may further include face detecting means for detecting a face region from the image of interest, wherein the sample acquiring means may acquire, as the skin color sample region, a region of a predetermined range contained in the face region detected by the face detecting means.

An aspect of the skin color detection method according to the invention include: generating with model generating means, for each person contained in an image of interest, a skin color model used to determine whether or not each pixel of the image of interest has a skin color; and detecting with detecting means a skin color region comprising pixels having the skin color from the image of interest with referencing the skin color model.

The skin color detection method according to the invention may be provided in the form of a computer-readable recording medium containing a program for causing a computer to carry out the method.

According to the skin color detection device and method of the invention, a skin color model used to determine whether or not each pixel of the image of interest has a skin color is generated for each person contained in an image of interest, and the skin color model is referenced to detect a skin color region comprising pixels having the skin color from the image of interest. The generated skin color model is therefore suitable for the skin color of the person contained in the image of interest, and use of the generated skin color model allows accurate detection of the skin color region from the image of interest.

If more than one persons are contained in the image of interest, the skin color model is generated for each person. In this case, the skin color region is detected for each of the more than one generated skin color models, thereby detecting the skin color region for each person contained in the image of interest.

Further, by acquiring the skin color sample region from the image of interest, extracting the plurality of features from the skin color sample region, and statistically generating, based on the features, the skin color model used to determine whether or not each pixel of the image of interest has a skin color, the skin color model which is more suitable for the skin color contained in the image of interest can be generated.

Moreover, by detecting a face region from the image of interest and acquiring, as the skin color sample region, a region of a predetermined range contained in the detected face region, automatic acquisition of the skin color sample region, from which the features used to generate the skin color model are extracted, can be achieved.

### BRIEF DESCRIPTION OF THE DRAWINGS

FIG. 1 is a schematic block diagram illustrating the configuration of a skin color detection device to which a skin color model generation device according to an embodiment of the present invention is applied,

FIG. 2 shows an example of an image of interest,

FIG. 3 is a flow chart of a skin color model generation process,

FIG. 4 is a flow chart of a skin color region detection process,

FIG. 5 is a diagram for explaining generation of a probability map,

FIG. 6 is a diagram for explaining integration of the probability maps, and

FIG. 7 is a diagram for explaining generation of a skin color mask.

### DESCRIPTION OF THE PREFERRED EMBODIMENTS

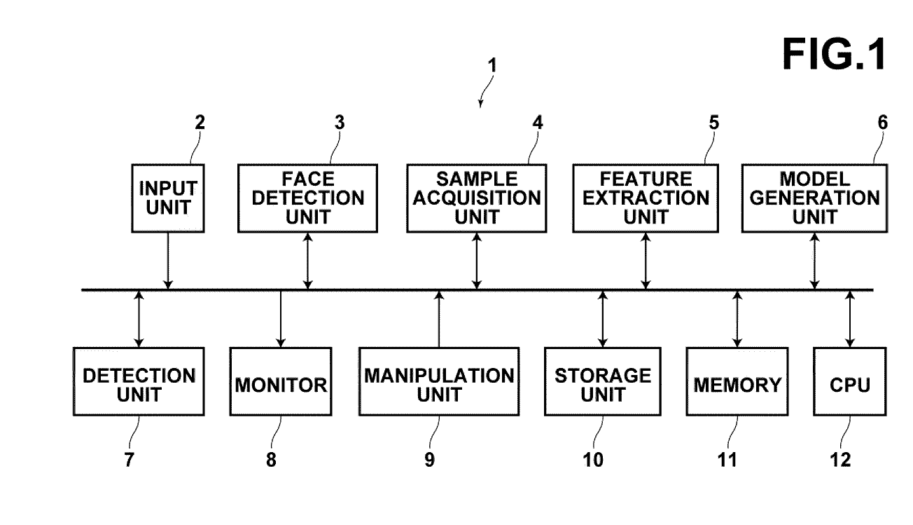

Hereinafter, an embodiment of the present invention will be described with reference to the drawings. FIG. 1 is a schematic block diagram illustrating the configuration of a skin color detection device to which a skin color model generation device according to an embodiment of the invention is applied. As shown in FIG. 1, a skin color detection device 1 according to this embodiment includes: an input unit 2 for inputting an image of interest, from which a skin color region is to be detected, to the device 1; a face detection unit 3, which detects a face region from the image of interest; a sample acquisition unit 4, which acquires a skin color sample region from the detected face region; a feature extraction unit 5, which extracts a plurality of features from the skin color sample region; a model generation unit 6, which statistically generates, based on the features, a skin color model used to determine whether or not each pixel of the image of interest has a skin color; and a detection unit 7, which detects a skin color region from the image of interest using the generated model.

The skin color detection device 1 further includes: a monitor 8, such as a liquid crystal display, which displays various items including the image of interest; a manipulation unit 9 including, for example, a keyboard and a mouse, which is used to enter various inputs to the device 1; a storage unit 10, such as a hard disk, which stores various information; a memory 11, which provides a work space for various operations; and a CPU 12, which controls the units of the device 1.

It should be noted that, in this embodiment, pixel values of pixels of the image of interest include R, G and B color values.

The input unit 2 includes various interfaces used to read out the image of interest from a recording medium containing the image of interest or to receive the image of interest via a network.

The face detection unit 3 detects the face region from the image of interest. Specifically, the face detection unit 3 detects a rectangular face region surrounding a face from the image of interest using, for example, template matching or a face/non-face classifier, which is obtained through machine learning using a number of sample face images. It should be noted that the technique used to detect the face is not limited to the above examples, and any technique, such as detecting a region having the shape of a contour of a face in the image as the face, may be used. The face detection unit 3 normalizes the detected face region to have a predetermined size. If more than one persons are contained in the image of interest, the face detection unit 3 detects all the face regions.

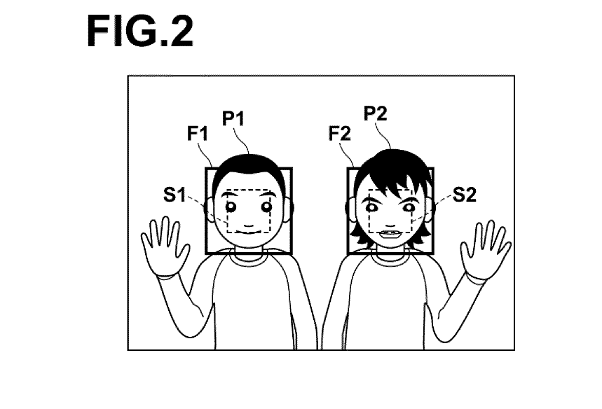

The sample acquisition unit 4 acquires the skin color sample region from the face region detected by the face detection unit 3. FIG. 2 shows an example of the image of interest for explaining how the skin color sample region is acquired. As shown in FIG. 2, if the image of interest contains two persons P1 and P2, two face regions F1 and F2 are detected from the image of interest. The sample acquisition unit 4 acquires, as skin color sample regions S1 and S2, rectangular regions which respectively have smaller areas than areas of the face regions F1 and F2 by a predetermined rate with centers of the face regions F1 and F2 being the intersecting points of diagonal lines of the respective skin color sample regions. For example, the areas of the skin color sample regions S1 and S2 are respectively ¼ of the areas of the face regions F1 and F2.

It should be noted that, if the skin color sample region contains components of the face, such as the eyes, the nose and the mouth, the sample acquisition unit 4 may remove these components from the skin color sample region.

The feature extraction unit 5 extracts the features of each pixel contained in the skin color sample region. Specifically, in this embodiment, seven features including hue (Hue), saturation (Saturation) and luminance (Value) (hereinafter referred to as H, S, V), edge strength, and normalized R, G and B values of each pixel are extracted. It should be noted that, if more than one skin color sample regions are acquired, the features are extracted for each skin color sample region.

The hue H, saturation S and luminance V values are calculated according to equations (1) to (3) below, respectively. The edge strength is calculated through filtering using a known differential filter. The normalized R, G and B values, Rn, Gn and Bn, are calculated according to equations (4) to (6) below, respectively.

$$\begin{matrix}{H}_{1} = {cos}^{- 1} \{ \frac{0.5 [ ( R - G ) + ( R - B ) ]}{\sqrt{( R - G ) ( R - G ) + ( R - B ) ( G - B )}} \} & \\ H = \{ \begin{matrix}{H}_{1} & if B \leq G \\ 360 ° - {H}_{1} & if B > G\end{matrix} & ( 1 ) \\ S = \frac{max ( R , G , B ) - min ( R , G , B )}{max ( R , G , B )} & ( 2 ) \\ V = \frac{max ( R , G , B )}{255} & ( 3 ) \\ {R}_{n} = \frac{R}{R + G + B} & ( 4 ) \\ {G}_{n} = \frac{G}{R + G + B} & ( 5 ) \\ {B}_{n} = \frac{B}{R + G + B} & ( 6 )\end{matrix}$$

The model generation unit 6 generates seven histograms, each representing frequency with respect to corresponding one of the seven features, and approximates the seven histograms with a Gaussian mixture model according to equation (7) below. It should be noted that, if the image of interest contains more than one persons, the Gaussian mixture model is calculated for each person.

$$p ( x ; {μ}_{k} , {\sum }_{k} , {π}_{k} ) = {\sum }_{k = 1}^{m} {π}_{k} {p}_{k} ( x ) \\ where \text{:} {π}_{k} ≧ 0 , {\sum }_{k = 1}^{m} πk = 1 \\ {p}_{k} ( x ) = \frac{1}{{( 2 π )}^{D / 2} {\vert {\sum }_{k} \vert}^{1 / 2}} \cdot exp \{ - \frac{1}{2} {( x - {μ}_{k} )}^{T} {\sum }_{k}^{- 1} ( x - {μ}_{k} ) \} \qquad ( 7 )$$

wherein m is the number of features (seven in this example), μₖ is an expectation value vector, Σₖ is a covariance matrix, πₖ is a weighting factor, and p(x; μₖ, Σₖ, πₖ) is a normal density distribution with the expectation value vector, the covariance matrix and the weighting factor being parameters thereof.

Then, the model generation unit 6 estimates the parameters, i.e., the expectation value vector μₖ, the covariance matrix Σₖ and the weighting factor πₖ, using an EM algorithm. First, as shown by equation (8) below, a logarithmic likelihood function L(x, θ) is set. The θ here is the parameters μₖ, Σₖ and πₖ.

$$\begin{matrix}L ( x , θ ) = log p ( x , θ ) \\ = {\sum }_{i = 1}^{n} log \{ {\sum }_{k = 1}^{m} {π}_{k} {p}_{k} ( x ) \}\end{matrix} \qquad ( 8 )$$

wherein n is the number of pixels in the skin color sample region.

The model generation unit 6 estimates, using the EM algorithm, the parameters which maximize the logarithmic likelihood function L(x, θ). The EM algorithm includes an E step (Expectation step) and an M step (Maximization step). First, in the E step, appropriate initial values are set for the parameters, and a conditional expectation value Eₖi is calculated according to equation (9) below.

$${K}_{kj} = \frac{{π}_{k} {p}_{k} ( x )}{{\sum }_{j = 1}^{m} {π}_{j} {p}_{j} ( x )} \qquad ( 9 )$$

Then, using the conditional expectation value Eₖi calculated in the E step, the parameters are estimated in the M step according to equations (10) to (12) below.

$${π}_{k} = \frac{1}{n} {\sum }_{i = 1}^{n} {E}_{ki} \qquad ( 10 )$$

By repeating the E step and the M step, the parameters, i.e., the expectation value vector μₖ, the covariance matrix Σₖ and he weighting factor πₖ, which maximize L(x, θ) are determined. Then, the determined parameters are applied to equation (7), and the process of generating the skin color model ends. When a pixel value of each pixel of the image of interest is inputted, the thus generated skin color model outputs a value representing probability of the pixel having the skin color. The generated skin color model is stored in the storage unit 10. It should be noted that, if the image of interest contains more than one persons, the skin color model is generated for each person.

The detection unit 7 applies the skin color model to each pixel of the image of interest to calculate the value representing probability of each pixel having the skin color. Then, the detection unit 7 generates a probability map for each skin color model, and detects the skin color region based on the probability map. Details of the process carried out by the detection unit 7 will be described later.

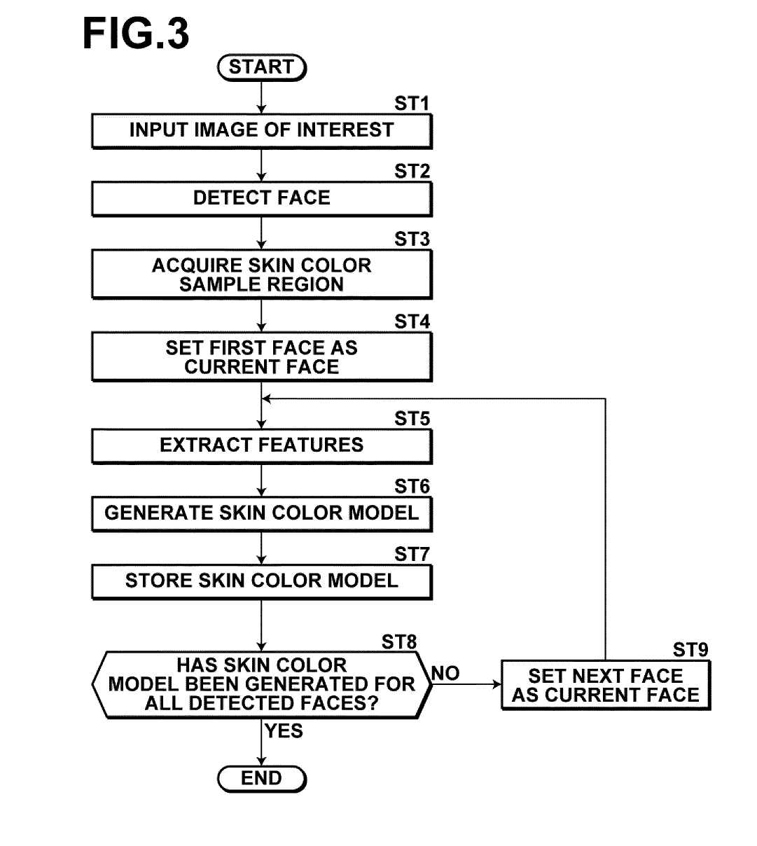

Next, the process carried out in this embodiment is described. FIG. 3 is a flow chart of the skin color model generation process carried out in this embodiment. When the operator operates the manipulation unit 9 to instruct the device 1 to generate the skin color model, the CPU 12 starts the process, and the input unit 2 inputs the image of interest to the device 1 (step ST1). Then, the face detection unit 3 detects a face(s) from the image of interest (step ST2), and the sample acquisition unit 4 acquires the skin color sample regions from all the detected faces (step ST3).

Then, the first face of the detected faces is set as a current face to be subjected to the skin color model generation process (step ST4), and the feature extraction unit 5 extracts the plurality of features from the skin color sample region acquired from the face (step ST5). Then, the model generation unit 6 generates the skin color model based on the features as described above (step ST6), and the generated model is stored in the storage unit 10 (step ST7). Subsequently, the CPU 12 determines whether or not the skin color model has been generated for all the detected faces (step ST8). If the determination in step ST8 is negative, the next face is set as the current face to be subjected to the skin color model generation process (step ST9). Then, the process returns to step ST5, and the feature extraction unit 5 and the model generation unit 6 are controlled to repeat the operations in step ST5 and the following steps. If the determination in step ST8 is affirmative, the process ends.

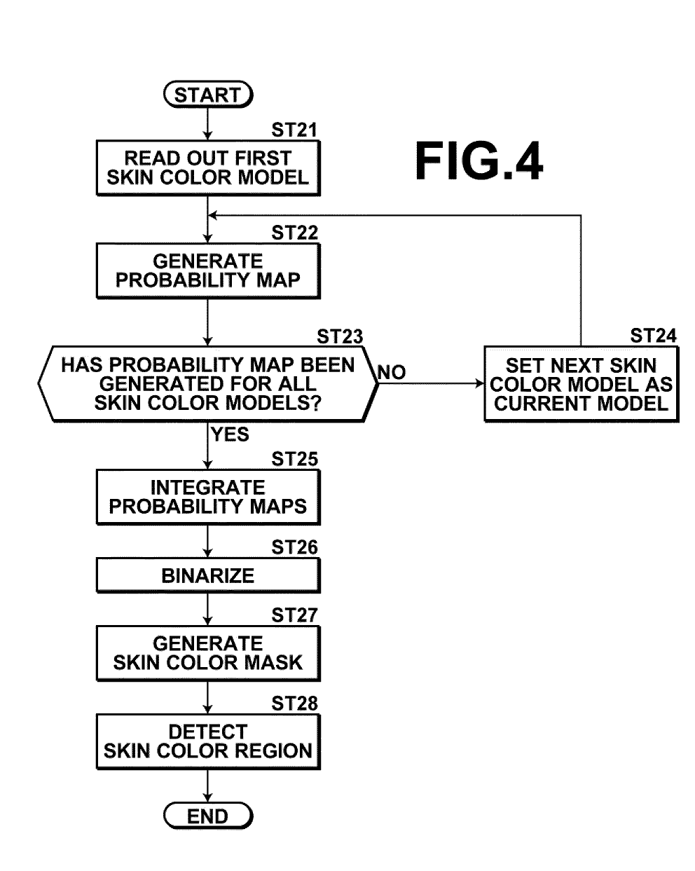

Next, detection of the skin color region is described. FIG. 4 is a flow chart of a skin color region detection process. When the operator operates the manipulation unit 9 to instruct the device 1 to detect the skin color region, the CPU 12 starts the process, and the detection unit 7 reads out the first skin color model from the storage unit 10 (step ST21). Then, each pixel of the image of interest is applied to the skin color model to generate a probability map of the image of interest with respect to the skin color model (step ST22). The probability map represents probability values calculated for the pixel values of the pixels of the image of interest.

Subsequently, the CPU 12 determines whether or not the probability map has been generated for all the skin color models (step ST23). If the determination in step ST23 is negative, the next skin color model is set as the current skin color model (step ST24), and the operation in step ST22 is repeated until affirmative determination is made in step ST23.

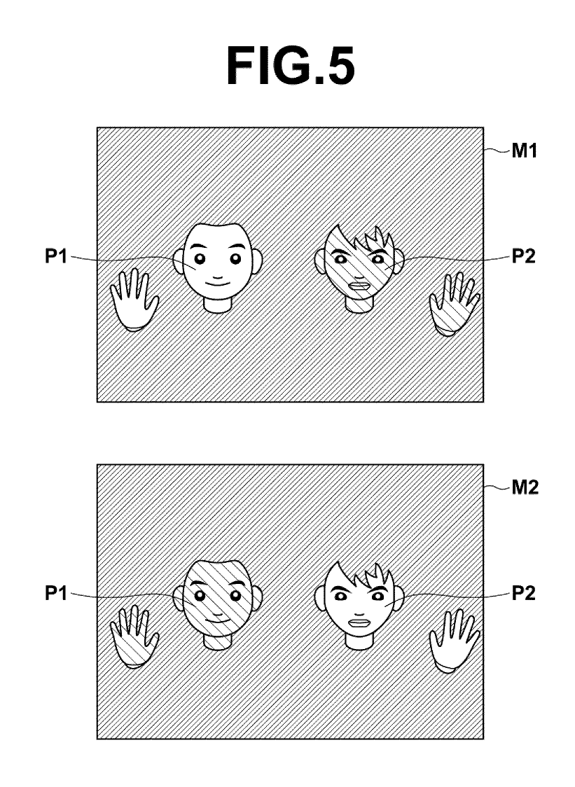

FIG. 5 is a diagram for explaining generation of the probability map. It should be noted that, in this explanation, the image of interest shown in FIG. 2 is used. In the probability maps shown in FIG. 5, areas with denser hatching have lower probability values. When the skin color model corresponding to the person P1 on the left is used, a probability map M1 shows higher probability for the pixels of the person P1 on the left and lower probability for the pixels of the person P2 on the right. In contrast, when the skin color model corresponding to the person P2 on the right is used, a probability map M2 shows higher probability for the pixels of the person P2 on the right, and lower probability for the pixels of the person P1 on the left.

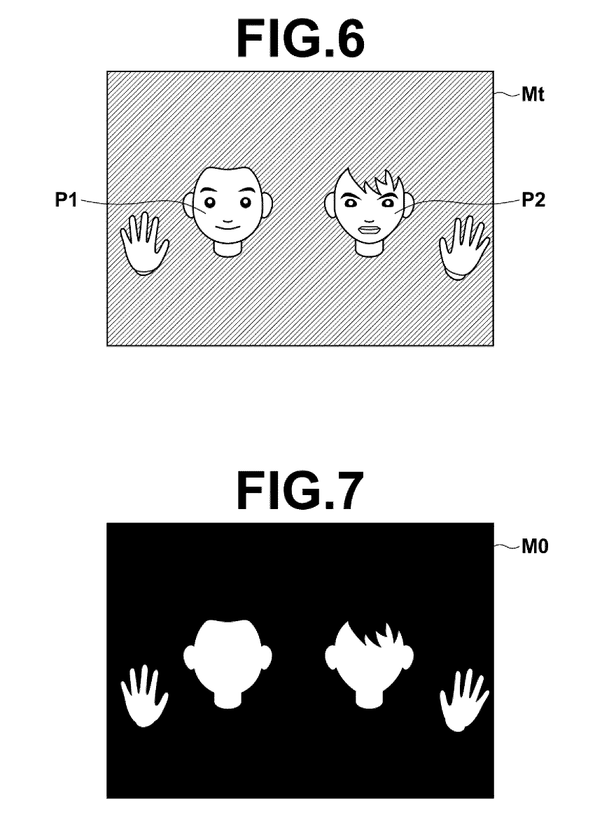

Subsequently, the detection unit 7 integrates the probability maps (step ST25). The integration of the probability maps is achieved by adding up the corresponding pixels between the probability maps. FIG. 6 is a diagram for explaining the integration of the probability maps. As shown in FIG. 6, by integrating the probability maps M1 and M2, an integrated probability map Mt showing high probability both for the pixels of the faces of the persons P1 and P2 is generated.

Then, the detection unit 7 binarizes the integrated probability map using a threshold value Th1 to separate the skin color region from a region other than the skin color region in the integrated probability map (step ST26). Then, removal of isolated points and filling is carried out for the separated skin color region and the region other than the skin color region to generate a skin color mask (step ST27). The removal of isolated points is achieved by removing the skin color regions having a size smaller than a predetermined size contained in the region other than the skin color region. The filling is achieved by removing regions other than the skin color region having a size smaller than a predetermined size contained in the skin color region. In this manner, the skin color mask M0 as shown in FIG. 7 is generated.

Then, the detection unit 7 detects the skin color regions from the image of interest using the generated skin color mask (step ST28), and the process ends.

As described above, in this embodiment, the skin color model, which is used to determine whether or not each pixel of the image of interest has the skin color, is generated using the features of the skin color sample region(s) acquired from the image of interest. The thus generated skin color model is suitable for the skin color(s) contained in image of interest, and use of the generated skin color model allows accurate detection of the skin color region(s) from the image of interest.

Further, in this embodiment, the skin color model is generated for each person contained in the image of interest, and the skin color region is detected from the image of interest with referencing the skin color model. The thus generated skin color model is suitable for the skin color(s) of the person(s) contained in image of interest, and use of the generated skin color model allows accurate detection of the skin color region(s) from the image of interest.

In particular, since the skin color model used to determine whether or not each pixel of the image of interest has the skin color is generated using the features of the skin color sample region(s) acquired from the image of interest, the skin color model more suitable for the skin color(s) contained in the image of interest can be generated.

Further, automatic acquisition of the skin color sample region can be achieved by detecting the face region(s) from the image of interest and acquiring a region of a predetermined range contained in the detected face region as the skin color sample region.

If the image of interest contains more than one persons, the skin color model is generated for each person. This allows accurate detection of the skin color regions of all the persons contained in the image of interest.

It should be noted that, although the face detection unit 3 detects the face region from the image of interest in the above-described embodiment, the operator may be allowed to specify the face region via the manipulation unit 9 from the image of interest displayed on the monitor 8.

Although the sample acquisition unit 4 acquires the skin color sample region from the face region in the above-described embodiment, the operator may be allowed to specify the skin color sample region via the manipulation unit 9 from the image of interest displayed on the monitor 8.

Although the seven features, i.e., the hue, saturation, luminance, edge strength and normalized R, G and B values, of each pixel are used to generate the skin color model in the above-described embodiment, the features to be used are not limited to the features used in the above embodiment. For example, the skin color model may be generated using the features of each pixel including only the hue, saturation and luminance values, or may be generated using features other than the above-described seven features.

Although the statistic distribution of the plurality of features is approximated with the Gaussian mixture model and the skin color model is generated through the EM algorithm using the Gaussian mixture model in the above-described embodiment, the technique used to generate the skin color model is not limited to the technique described in the above embodiment, and any technique may be used as long as it allows generation of the skin color model for each person contained in the image of interest.

In the above-described embodiment, all the skin color regions contained in the image of interest are detected using the generated skin color models. The skin color regions may be labeled for each skin color model. For example, in the case of the image of interest shown in FIG. 2, the probability maps M1 and M2 for the persons P1 and P2, respectively, are generated as shown in FIG. 5. Therefore, the regions having higher values in the probability maps M1 and M2 (i.e., the regions having values higher than a predetermined threshold value) may be labeled separately. In the case of the image of interest shown in FIG. 2, the skin color region of the person P1 on the right and the skin color region of the person P2 on the left are labeled with different labels. This allows detection of the skin color region for each person.

Further, in the case of the probability map M1, the skin color model is generated using the skin color sample region acquired from the face region of the person P1, and therefore the pixels of the face region of the person P1 has high probability values. However, since the skin color of the face and the skin color of the hand do not necessarily match with each other, the pixels of the hand region of the person P1 has lower probability values than those of the face region. Thus, even when the same skin color model is used, the skin color region having higher probability values and the skin color region having lower probability values may be labeled with different labels. For example, the probability values may be classified using two or more threshold values, and the regions may be labeled with different labels according to the classification of the probability values. This allows separate detection of the skin color region of the face and the skin color regions of body parts other than the face.

Furthermore, even when the face region and the hand region have the same skin color, the face region and the hand region have different sizes. Therefore, the skin color regions may be labeled with different labels according to the size.

For the eyes and the mouth, although they have skin colors corresponding to the face, their colors largely differ from the skin colors of other parts of the face. Therefore, after the skin color regions have been detected using the skin color mask, the probability maps M1 and M2 may be applied again to label the skin color region having lower probability values (for example, a skin color region having probability values not more than a threshold value Th2) and the skin color region having higher probability values of the detected skin color regions with different labels. This allows detection of the skin color regions of the faces excluding components such as the eyes and the mouth of the faces.

The skin color detection device 1 according to one embodiment of the invention has been described. It should be noted that the invention may also be implemented in the form of a program that causes a computer to function as means corresponding to the input unit 2, the face detection unit 3, the sample acquisition unit 4, the feature extraction unit 5, the model generation unit 6 and the detection unit 7 and to carry out the processes shown in FIGS. 3 and 4. Further, the invention may also be implemented in the form of a computer-readable recording medium containing such a program.

What is claimed is:

1. A skin color model generation device comprising:
sample acquiring means for acquiring a skin color sample region from an image of interest;
feature extracting means for extracting a plurality of features from the skin color sample region; and
model generating means for statistically generating, based on the features, a skin color model used to determine whether or not each pixel of the image of interest has a skin color.

2. The skin color model generation device as claimed in claim 1, wherein the model generating means generates the skin color model by approximating statistic distributions of the features with a Gaussian mixture model, and applying an EM algorithm using the Gaussian mixture model.

3. The skin color model generation device as claimed in claim 1, further comprising
face detecting means for detecting a face region from the image of interest,
wherein the sample acquiring means acquires, as the skin color sample region, a region of a predetermined range contained in the face region detected by the face detecting means.

4. The skin color model generation device as claimed in claim 3, wherein, if more than one face regions are detected from the image of interest, the model generating means generates the skin color model for each face region.

5. A skin color model generation method comprising:
acquiring a skin color sample region from an image of interest;
extracting a plurality of features from the skin color sample region; and
statistically generating, based on the features, a skin color model used to determine whether or not each pixel of the image of interest has a skin color.

6. A computer-readable recording medium containing a program for causing a computer to carry out a skin color model generation method, the method comprising:
acquiring a skin color sample region from an image of interest;
extracting a plurality of features from the skin color sample region; and
statistically generating, based on the features, a skin color model used to determine whether or not each pixel of the image of interest has a skin color.

7. A skin color detection device comprising:
skin color model generating means for generating, for each person contained in an image of interest, a skin color model used to determine whether or not each pixel of the image of interest has a skin color; and
detecting means for detecting a skin color region comprising pixels having the skin color from the image of interest with referencing the skin color model.

8. The skin color detection device as claimed in claim 7, wherein, if more than one skin color models are generated, the detecting means detects the skin color region for each skin color model.

9. The skin color detection device as claimed in claim 7, wherein the skin color model generating means comprises:
sample acquiring means for acquiring a skin color sample region from the image of interest;
feature extracting means for extracting a plurality of features from the skin color sample region; and
model generating means for statistically generating the skin color model based on the features.

10. The skin color detection device as claimed in claim 9, wherein the model generating means generates the skin color model by approximating statistic distributions of the features with a Gaussian mixture model, and applying an EM algorithm using the Gaussian mixture model.

11. The skin color detection device as claimed in claim 9, further comprising
face detecting means for detecting a face region from the image of interest,
wherein the sample acquiring means acquires, as the skin color sample region, a region of a predetermined range contained in the face region detected by the face detecting means.

12. A skin color detection method comprising:
generating with model generating means, for each person contained in an image of interest, a skin color model used to determine whether or not each pixel of the image of interest has a skin color; and
detecting with detecting means a skin color region comprising pixels having the skin color from the image of interest with referencing the skin color model.

13. A computer-readable recording medium containing a program for causing a computer to carry out a skin color detection method, the method comprising:
generating, for each person contained in an image of interest, a skin color model used to determine whether or not each pixel of the image of interest has a skin color; and
detecting a skin color region comprising pixels having the skin color from the image of interest with referencing the skin color model.
